(19) United States
(12) Patent Application Publication
(10) Pub. No.: US 2007/0024440 A1
(43) Pub. Date: Feb. 1, 2007

(54) School bus tracking and notification system

(75) Inventors: Theodore J. Moran, East Amherst, NY (US); Shengqiang Wang, Raleigh, NC (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/193,544

(22) Filed: Jul. 28, 2005

(51) Int. Cl. H04Q 7/00; G08B 1/08

(52) U.S. Cl. 340/539.13

(57) ABSTRACT

In a school bus tracking system, each school bus is provided with a mobile station and an ID. The bus ID's and telephone numbers for the buses' mobile stations are stored in a tracking application/database. At a residence, a parent sends a message to the tracking application that includes the ID of a bus that services the residence, and a radius. The message may be sent using a short message service, i.e., a text message to a particular address utilized by the tracking application. Then, the tracking application causes the locations of the bus mobile station and the parent's mobile station to be periodically polled. When the bus mobile station comes within the radius, the tracking application issues a message to the parent mobile station alerting the parent that the bus is approaching. The system may be used to track other vehicles, objects (e.g., packages), and/or persons.

### FIELD OF THE INVENTION

The present invention relates to communications and, more particularly, to wireless systems for tracking and scheduling moving objects.

### BACKGROUND OF THE INVENTION

In many countries including the United States, school buses are used to ferry students to and from school. Typically, school buses travel along set routes, passing from house to house or from bus stop to bus stop, stopping to pick up or discharge students at designated times. However, school buses do not always arrive at the pre-designated stops on time, as a result of traffic conditions, weather, or the like. In the winter season especially, and/or when raining, children sometimes have to suffer harsh weather conditions for a half hour or longer while waiting for the school bus at a school bus stop. In addition, children often actively play and chase each other at school bus stops. Longer waiting periods increase the probability of traffic accidents, as well the potential for interaction with unwelcome strangers, e.g., abduction.

### SUMMARY OF THE INVENTION

According to an embodiment of the present invention, a school bus tracking and notification system utilizes the infrastructure of an existing cellular communications network (e.g., mobile phone network) for tracking school buses, other vehicles, and other objects or items. Each school bus is provided with a mobile station (e.g., mobile phone) and a unique bus identifier (“ID”). A computer-based tracking and notification application is operably connected to the cellular network, and has a database portion that stores the bus ID's and the respective communication identifiers of the mobile stations carried on the buses (e.g., telephone numbers or other identifiers).

In operation, a parent or student at a residence or other location sends a message to the tracking application. The message includes the ID of a bus that services the residence, and a geographical radius or range. Alternatively, instead of a bus ID, the message can directly include the communication identifier of the mobile station in the bus. The message may be sent using the parent or student's mobile station over the network's short messaging service, e.g., a text message to a particular message address utilized by the tracking application. Then, the tracking application causes the cellular network to periodically poll the locations of the bus mobile station and the parent mobile station, using the network's location service function. When the bus mobile station comes within the designated radius, the tracking application issues a message or other notification to the parent mobile station alerting the parent or student that the bus is approaching. The student is then able to walk to the bus stop in a more accurate and timely manner, and without having to unnecessarily wait.

According to an additional embodiment of the present invention, information relating to the location of the bus mobile station is directed to an Internet website accessible by the student or parent. The location information may be cross-referenced to a computer-generated map showing the relevant locality, e.g., the town or city where the student resides. Alternatively, or in addition, the website can display a message indicating when the bus has come within the designated radius. This would allow a student to work on homework on a computer while waiting for the bus to arrive.

As indicated, it should be noted that the principles of the present invention may be applied beyond merely the tracking of school buses and other vehicles. Rather, the invention contemplates tracking air cargo, shipping freight, truck deliveries, and/or the transportation of any valuable and/or dangerous persons, items, or merchandise. Thus, in a more general sense, the present invention may be characterized as a method of tracking a mobile station, wherein the tracking process is initiated by a third party (meaning a person not currently in possession or control of the tracked mobile station, e.g., a parent or student) from a remote device (meaning a device, other than the tracked mobile station, that is not part of the polling infrastructure, e.g., a parent mobile station), and wherein the tracking notification is sent back to the third party. Additionally, providing a designated radius is optional, since the tracking notification may include the coordinates of the tracked mobile station, or information relating to the relationship between the tracked mobile station and remote device that is not expressed in terms of a radius or other criteria (e.g., a distance between the two).

### BRIEF DESCRIPTION OF THE DRAWINGS

The present invention will be better understood from reading the following description of non-limiting embodiments, with reference to the attached drawings, wherein below:

FIG. 1 is a schematic diagram of a school bus tracking and notification system according to an embodiment of the present invention;

FIG. 2 is another schematic diagram of the school bus tracking and notification system;

FIGS. 3-6 are flowcharts showing how different aspects of the school bus tracking and notification system are implemented;

FIG. 7 is a schematic diagram of a database system portion of the school bus tracking and notification system;

FIG. 8 is a flowchart showing the operation of a reassignment module;

FIG. 9 is a schematic diagram of a graphic interface version of the reassignment module;

FIG. 10 is a schematic diagram of an alternative embodiment of a database portion of the school bus tracking and notification system;

FIG. 11 is another schematic diagram of the tracking and notification system;

FIG. 12 is a flowchart of a tracking algorithm; and

FIG. 13 is a schematic diagram of an optional website for displaying tracking information.

### DETAILED DESCRIPTION

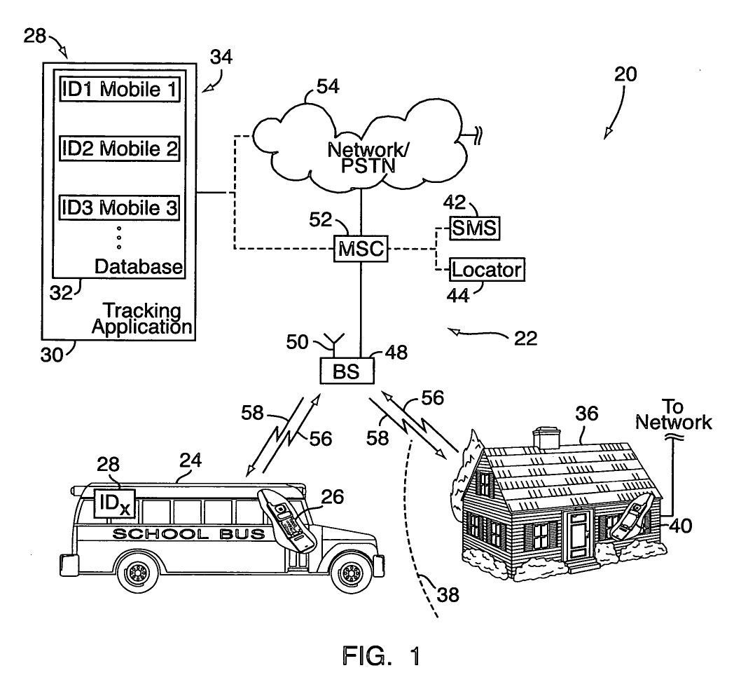

According to an embodiment of the present invention, with reference to FIGS. 1-12, a school bus tracking and notification system 20 utilizes the infrastructure of an existing cellular communications network 22 (e.g., mobile phone network) for tracking school buses 24. Each school bus 24 is provided with a mobile station 26 (e.g., mobile phone) and a unique bus identifier (“ID”) 28. A tracking application system 30 is operably connected to the cellular network 22, and has a database portion 32 that stores the bus ID's 28 and the buses' mobile stations' respective communications identifiers 34, e.g., mobile station telephone numbers or other identifiers.

For initiating a notice from the tracking application system 30, a parent or student, located at a residence or other remote location 36, sends a message or other stimulus to the tracking application system 30. The message includes the ID 28 of a bus that services the residence, and a geographical radius or range 38. The message is sent from a remote device 40. For example, the message may be sent using the parent or student's mobile station over the cellular network's short messaging service 42 (“SMS”), i.e., a text message to a particular message address utilized by the tracking application system 30. Then, the tracking application system 30 causes the cellular network 22 to periodically poll the respective locations of the bus mobile station 26 and the remote device 40, using the cellular network's location service function 44. When the bus mobile station 26 comes within the designated radius 38, the tracking application system 30 issues a message to the remote device 40 (or to another electronic device at the residence or other remote location, e.g., a computer) alerting the parent or student that the bus is approaching.

The present invention is applicable to tracking vehicles other than school buses, and to tracking non-vehicular objects associated with a mobile station 26, e.g., the object is provided with a mobile station for tracking purposes. By “mobile station,” it is meant a general-purpose wireless communications device for transmitting voice and data across a cellular network or other wireless network. As should be appreciated, in a broad sense the present invention relates to a mobile station tracking process initiated at the behest of, and for the benefit of, a third party, i.e., someone not directly currently controlling or possessing the tracked mobile station 26, such as a parent or student. In carrying out the tracking procedure, the tracking application system 30 receives a stimulus (meaning a message or other communication), from a remote device 40 controlled by the third party. Based on the stimulus, the tracking application system 30 polls the location of the tracked mobile station 26. Additionally, the tracking application system 30 sends the tracking notification back to the remote device 40, or to another designated remote device. By “remote device,” it is meant an electronic device, other than the mobile station 26 being tracked (e.g., the bus mobile station 26), that is not part of the SMS 42 and/or location service function 44. Typically, the remote device will be located at a location away from the tracked mobile station. For example, the remote device may be the mobile station 40 located at the home 36, or a computer located at the home 36.

In light of the above, the present invention may be characterized in terms of who initiates the polling process, e.g., a third party such as a student or teacher. For example, the tracking application system 30 polls the location of the tracked mobile station 26 upon receiving some sort of stimulus from a remote device, e.g., a communication from a mobile station 40 operated by a third party such as a parent or student. The invention may also be characterized as to whom the notification is sent to, e.g., the third party. For example, a method carried out by the tracking application system 30, wherein the location of the tracked mobile station (e.g., the bus mobile station 26) is first polled, and then a notification regarding the polled location is sent to a remote device, e.g., to a mobile station 40 operated by a third party such as a parent or student.

A further aspect of the present invention relates to the tracking application system 30 only sending the notification to the remote device 40 upon determining that the location of the tracked mobile station (e.g., the bus mobile station 26, or a tracked mobile station associated with an object) satisfies one or more criteria with respect to a second location (e.g., the location of a house 36). For example, the criteria might be that the bus has come within the designated radius 38 of the house 36. Other criteria might be that the bus has come within a designated radius of a point near the house, or that the bus has passed multiple designated points with respect to the second location, as further discussed below. The second location may be a fixed location, e.g., the location of the house 36. However, in a broad sense the present invention is applicable to sending notifications when the location of the tracked mobile station 26 satisfies one or more criteria with respect to a second location, where the second location possibly varies as a result of the remote device 40 being moved.

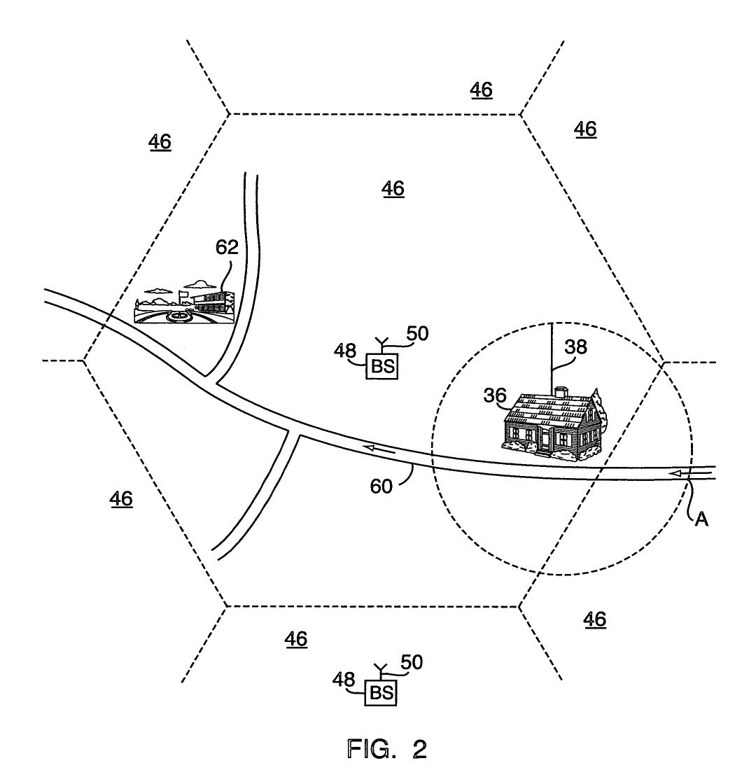

FIGS. 1 and 2 illustrate the topography of the cellular network 22, according to typical configurations. The network 22 is geographically divided into a number of cells or sectors 46, which are typically contiguous and which together define the coverage area of the network 22. Each cell 46 is served by a base station 48, which includes one or more fixed/stationary transceivers and antennae 50 for wireless communications with the mobile stations 26, 40. The base stations 48 are in turn connected (either wirelessly or through land lines) to a mobile switching center (“MSC”) 52, which serves a particular number of base stations depending on network capacity and configuration. The mobile switching center 52 acts as the interface between the wireless/radio end of the network 22 and a public switched telephone network or other network(s) 54, including performing the signaling functions necessary to establish calls or other data transfer to and from the mobile stations 26, 40.

Various methods exist for conducting wireless communications between the base stations 48 and mobile stations 26, 40. One such method is the CDMA (code division multiple access) spread-spectrum multiplexing scheme, widely implemented in the United States under the “IS-95,” “IS-2000,” or other standards. In a CDMA-based network, transmissions from the mobile stations 26, 40 to the base stations 48 are across a single frequency bandwidth known as the reverse link 56, e.g., 1.25 MHz centered at a first designated frequency. Generally, each mobile station 26, 40 is allocated the entire bandwidth all of the time, with the signals from individual mobile stations being differentiated from one another using an encoding scheme. Transmissions from the base stations 48 to the mobile stations 26, 40 are across a similar frequency bandwidth (e.g., 1.25 MHz centered at a second designated frequency) known as the forward link 58. The forward and reverse links may each comprise a number of traffic channels and signaling or control channels, the former primarily for carrying data, and the latter primarily for carrying the control, synchronization, and other signals required for implementing CDMA communications. Of course, the present invention is not limited to implementation in particular types of cellular networks or with particular communications protocols/methods. For example, the present invention could be implemented using a GSM network, which are common in Europe and Asia.

The tracking application 30 includes the database 32, and will typically be implemented in conjunction with a computer processor having associated memory and storage. For example, the tracking application 30 may be installed directly onto the cellular network's computer system, e.g., at the MSC 52, or it may run on a separate server computer or computer system that is operably connected to the network 22, via the MSC 52 or otherwise. As should be appreciated, depending on the particular network configuration, the tracking application 30 may be connected directly to the cellular communications network 22, or indirectly via the network 54.

As noted above, for initiating a notification from the tracking application 30, the parent or student communicates with the tracking application using the cellular network's SMS 42. The SMS 42 is an existing function of the cellular network that allows users to send text messages to one another over the cellular network 22. To send a text message, the message is keyed into the user's mobile station 40, and is then sent to a particular address. The address may be the recipient's mobile station telephone number, or, depending on the particular network/SMS system, it may be an address, number, or other identifier, e.g., a streamlined number or address designated for text messaging. The cellular network 22 (e.g., the MSC 52 or otherwise) processes the text message for routing to the recipient. Message length is usually limited to 80-160 characters, and the recipient can be a mobile station or a software application. Here, the tracking application system 30 is operably connected to the cellular network 22 for receiving text messages over the SMS 42.

In addition to sending text messages over the SMS 42, the system 20 may be provided with functionality for parents and students to contact the tracking application 30 in alternate manners. For example, the tracking application 30 could have an automatic voice system accessible by a remote device such as a phone. In this case, the parent or student would call a designated phone number using the mobile station 40 or a landline telephone. Upon establishing a connection, the voice system would prompt the parent or student to either speak or key in the radius 38 and bus ID 28. As another alternative, a website could be provided that would be accessible over the network 54 (e.g., the Internet) and in operable communication with the tracking application system 30. At the website, accessed through a remote computer terminal at the house 36, the parent or student would be able to enter the radius 38 and ID 28 into the tracking application 30. For a voice call or website entry, the parent or student would have to somehow supply the system 20 with information relating to the location of the house 36. This could be the communications identifier of the mobile station 40 (for location polling), geographic coordinates, or an account number or other shortened identifier corresponding to an entry in the database 32 where the house location information is stored.

The text message or other communication sent by the parent or student to the tracking application system 30 will include the radius 38 and the ID 28 of the bus 24 that services the house 36. The ID 28 will be provided to the parent or student by a school official. Typically, the parent or student will send the communication at some point well before the bus 24 is expected to arrive at the house or bus stop 36, e.g., at least fifteen minutes before the bus's scheduled arrival. The radius 38 will be chosen in advance to provide sufficient notice for the student, according to the bus's route and scheduled stops. For example, with reference to FIG. 2, if a bus travels along a route 60 past the house 36 to get to a school 62, in the direction indicated, the radius 38 will be chosen so that when the bus 24 comes within the radius 38 at point A, it will take the bus 24 at least five minutes or so to reach the house 36. This gives the student at least five minutes notice before the bus arrives at the house or other stop 36.

Once the initiating text message or other stimulus is received at the tracking application system 30 from the parent or student, the tracking application system 30 looks up the provided ID 28 in the database 32. Associated with the ID 28 is the mobile station communications identifier 34 (e.g., phone number or the like) for the mobile station 26 carried on the bus 24 that services the house or stop 36. Knowing the communications identifiers of both the bus mobile station 26 and parent mobile station 40 allows the tracking application system 30 to initiate a location polling procedure using the network's location service 44. The location service 44 is a function of the network 22 used to determine the geographic location of a mobile station 26, 40, for emergency services or otherwise. Mobile station location may be determined in a manner that is network specific. Thus, different cellular networks may use different mechanisms or methods for location polling, but that will typically involve triangulation with base stations 48 and/or GPS functionality.

As should be appreciated, instead of providing the tracking application system with an ID 28 of a bus 24, an ID could be provided for some other type of vehicle or object. Also, instead of providing an ID that is cross-referenced by the tracking application system 30 to the communications identifier of the mobile station 26, the communications identifier could be provided by the parent or student directly. Supplying a radius 38 or the like is optional, since the tracking application system 30 could be configured to either: i) make information relating to the location of the mobile station 26 accessible on a website, for displaying with respect to a map; and/or ii) send one or more notifications to the remote device 40 (e.g., parent mobile station) stating the distance between the tracked mobile station 26 and the second location 36, as determined by polling the location of the remote device. Alternatively, the tracking application system 30 could simply send a notification back to the remote device containing information relating to the tracked mobile station's location, but not necessarily with respect to the second location, e.g., the coordinates of the tracked mobile station. Thus, the patent, student, or other third party would send a message or other stimulus to the tracking application system 30, through the SMS 42 or otherwise. Then, the tracking application system 30 would poll the location of the tracked mobile station 26, and, optionally, the location of the remote device 40. Then, the tracking application system 30 would send a notification to the remote device. The notification would include information relating to the location of the tracked mobile station 26, e.g., geographic coordinates, the distance between the tracked mobile station 26 and the remote device 40, or a notification sent upon determining that the location of the tracked mobile station 26 satisfies one or more criteria with respect to a second location, e.g., the location of the house 36 as determined by polling the location of the remote device 40.

When the text message or other stimulus is received by the tracking application system 30, the tracking application system 30 initiates the location polling procedure by sending an appropriate command to the location service function 44, including the communications identifiers of the two mobile stations 26, 40. With this information, the location service 44 is able to poll the two mobile stations 26, 40 to determine their respective locations. A determination is then made if the bus mobile station 26 is within or without the radius 38. This can be done by the tracking application system 30, in which case the location service function 44 sends the locations back to the tracking application system 30 for processing. Otherwise, the tracking application system 30 can supply the location service function 44 with the radius 38 for the location service function 44 to perform the calculation. In either case, if the bus mobile station 26 is within the radius 38, the tracking application system 30 alerts the parent or student at the house or other location 36 that the bus 24 is approaching. The alert can take many forms, including a text message to the parent or student's mobile station 40, an automatic phone message, an e-mail, or the like.

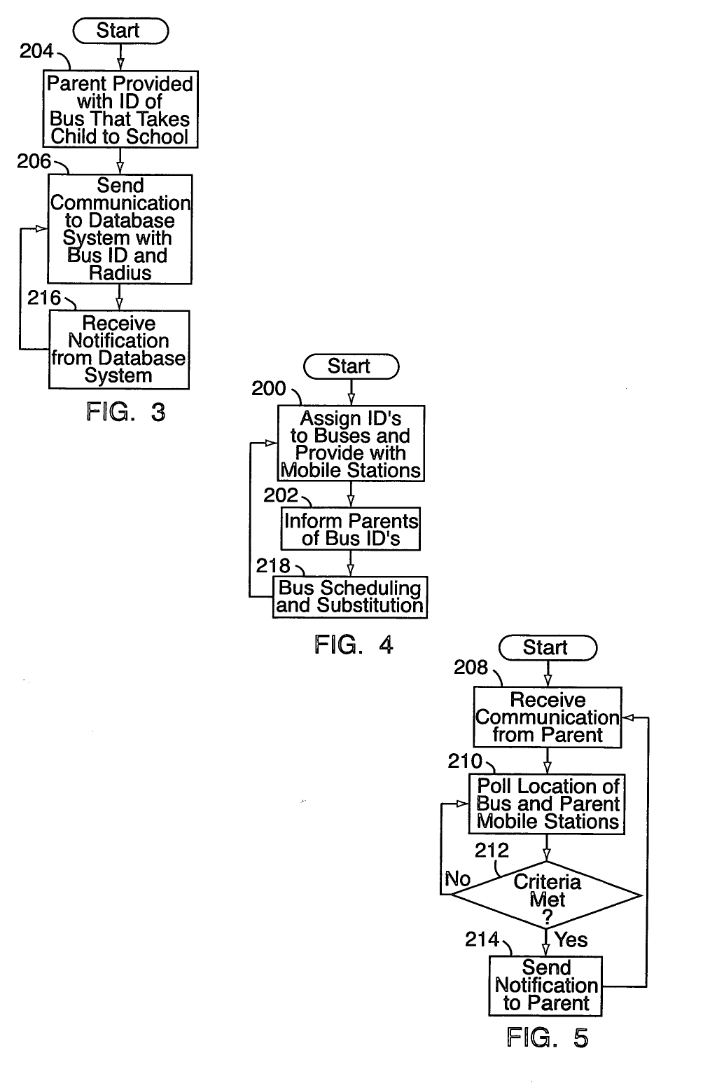

FIGS. 3, 4, and 5 summarize the above-described tracking and notification system 20 as it relates to the home or other location 36, school 62, and tracking application system 30, respectively. As indicated, at Step 200, school officials assign an ID 28 to each bus 24, and provide each bus 24 with a mobile station 26. This information is uploaded to the database 32. The ID's 28 may be internally generated by the school, or they may be in a format supplied from the tracking application system 30. For example, it may be the case that when the school stores an entry in the database 32, an ID 28 is automatically assigned for each entry, with the school making a note of the ID's 28 and associating the mobile station identifiers with the ID's 28 for each bus 24. At Steps 202 and 204, the school provides the parents/students with the ID's 28 for the buses 24 that stop at their respective houses or bus stops 36. At Step 206, the parent or student sends a text message or other communication to the tracking application 30 including the ID 28 and radius 38. At Step 208, the tracking application 30 receives the communication, and is able to determine the identifier of the parent's mobile station 40 from the text message or other communication, i.e., the text message will include the sender mobile's communications identifier. At Step 210, the locations of the bus mobile station 26 and remote device 40 are polled, as discussed above. At Step 212, it is determined if the criterion or criteria are met for the tracking application 30 to alert the parent or student. For example, one possible criterion is that the bus 24 be within the radius 38. If not, the polling is periodically repeated. If so, at Step 214, the tracking application 30 sends a text message or other notification, which is received by the parent at Step 216, alerting the parent or student that the bus 24 is approaching. As indicated at Step 218, the tracking application 30 may be configured to allow the school to perform other functions such as bus scheduling and substitution, as discussed in more detail below.

If the bus mobile station 26 is outside the radius 38, the tracking application system 30 will cause the location service function 44 to periodically poll the locations of the two mobile stations 26, 40 for tracking the bus 24. The rate of polling may be a set value, e.g., once every thirty seconds or once a minute, or it may vary depending on how close the bus 24 is to the radius. Thus, for example, if the bus 24 is very far away from the radius 38, as tends to indicate that the bus 24 will take a while to reach the radius 38, the polling rate may be reduced, e.g., to once every five or ten minutes. Then, as the bus approaches the radius, the polling rate may be increased. This ensures that the point of the bus 24 crossing the radius 38 is accurately tracked, while not needlessly wasting location-polling resources.

One possible implementation of this procedure is shown in FIG. 6. There, at Step 220, upon receiving a communication from a parent or student as at Step 222, the locations of the bus mobile station 26 and parent mobile station 40 are polled. At Step 224, it is determined whether or not the bus location is within the radius 38. If so, a notification is sent at Step 226. If not, at Step 228, it is determined whether the bus is within the radius 38 plus a value “X” (i.e., radius+X>radius). If so, the locations are polled again fairly soon, at Step 220. If not, that serves as an indication that the bus is far away. Thus, at Step 230, a calculation is made as to whether the bus is within the radius 38 plus a value “Y”, where Y is greater than X. If so, the locations are again polled as at Step 220, but only after a delay 232a. If not, that serves as an indication that the bus is even farther away, and a determination is made at Step 234 if the bus is within the radius 38 plus a value “Z”, where Z is greater than Y. If so, the locations are again polled as at Step 220, but only after a longer delay 232b, 232a. If not, that serves as an indication that the bus is very far away, and the locations are again polled as at Step 220, but only after a substantial delay 232c, 232b, 232a.

To further reduce the instances of location polling, the location of the remote device 40 may be programmed into the database 32 as a static value. For example, for each household utilizing the system 20, the communications identifiers of the household mobile stations 40 may be programmed into the database 32, along with the location of the house 36. Each time the tracking application system 30 is accessed using any of the household mobile stations 40 (or even a land-line phone), the tracking application 30 performs a lookup operation to determine the location of the house 36, as stored in the database 32, and based on the mobile station identifier. Then, only the location of the bus mobile station 26 has to be polled for performing the distance calculation. As an alternative, the system 20 can assume that the location of the remote device 40 will not change significantly during the polling process. As such, the location of the remote device 40 may be polled once at the beginning of each tracking/notification cycle, i.e., one time after the parent or student sends a communication to the tracking application 30, with that location being compared to the varying bus location thereafter, as determined through periodic polling of the bus mobile station 26.

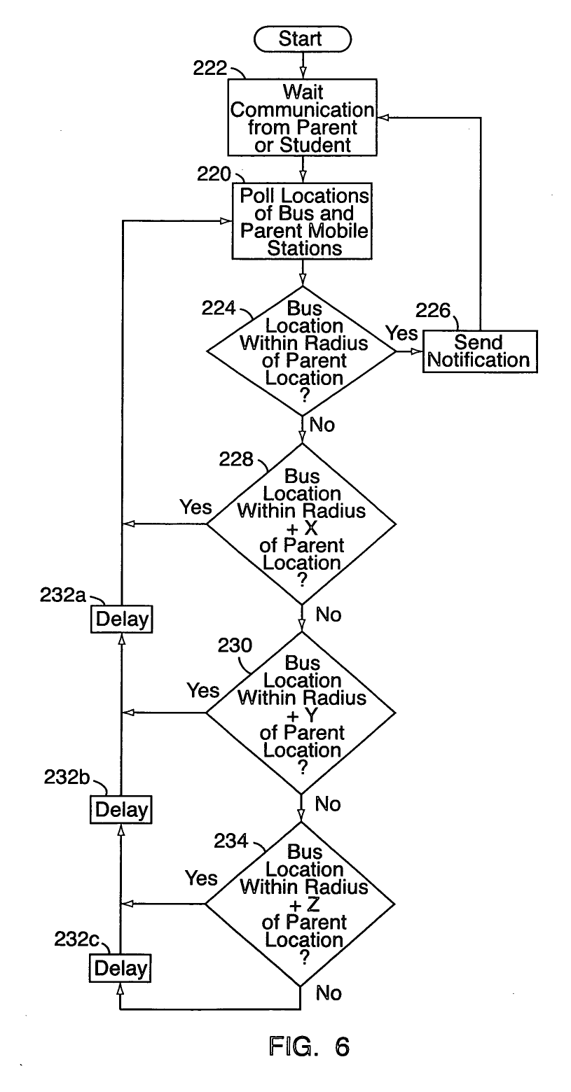

The tracking application system 30 may provide additional functionality to enhance the tracking and notification service. FIG. 7 shows a more detailed view of a possible embodiment of the tracking application 30. There, the tracking application 30 includes a secure server computer 64 or the like for interfacing with the Internet, PSTN, or other network 54. Various schools, school districts, or other organizations 62a, 62b, 62c are able to securely access the tracking application 30 over the Internet 54 and secure server 64, in a standard manner as is well known in the art. The tracking application 30 includes one or more accounts 66 for each school 62. Each account 66 includes, for example, a user name and password 68 for school officials to access the account, as well as listings 70 for the school's various buses 24. Each listing 70 includes a bus identifier 28 and the mobile station identifier 34 for mobile station 26 carried on the bus 24, as described above. Additionally, the listings 70 may include route data/information 72, as well as additional information regarding the bus 24 such as the driver's name and bus license plate number 74.

Further, the tracking application system 30 may include an interface or other functionality 76 for school officials to access the accounts 66 (hereinafter referred to as “school module” 76). The school module 76 would have a function or subroutine 78 allowing each school to add bus listings 70, a function/subroutine 80 for modifying existing bus listings 70, and a function/subroutine 82 for reassigning bus routes. Regarding the latter, it is oftentimes the case that a different bus may temporarily service a particular route if the bus regularly used for that route is out of service or on special duty. In such a situation, to ensure proper notification, the mobile station 26 for the regular bus may be moved over to the temporary bus.

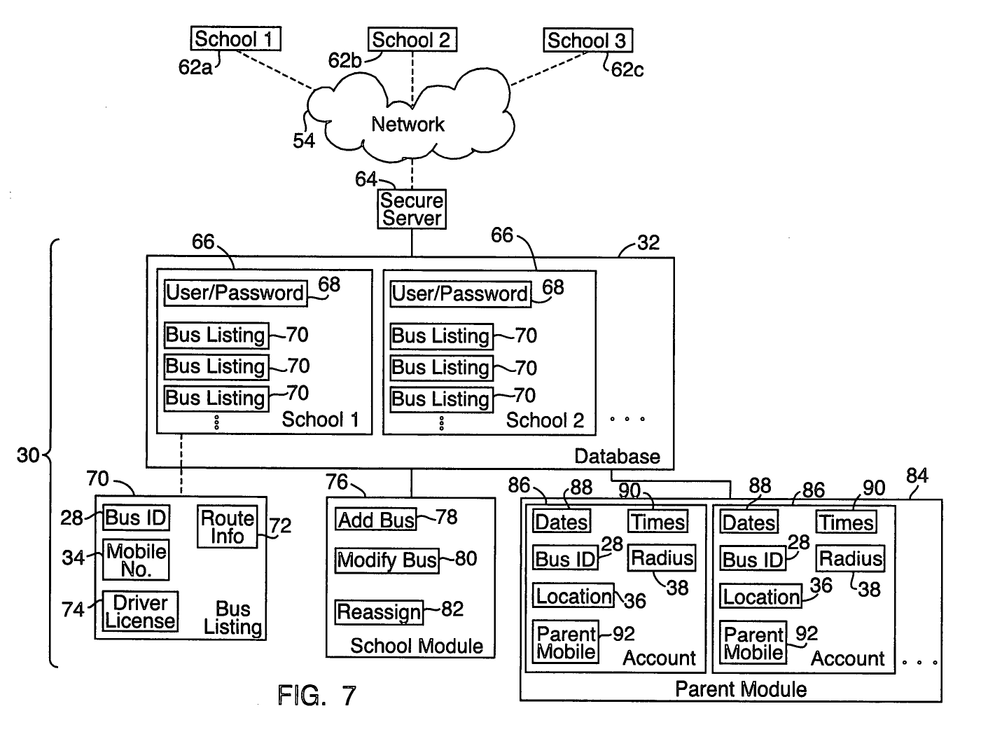

Alternatively, to avoid having to physically “reshuffle” bus mobile stations, the tracking application system 30 may be used for reassigning bus routes using the reassignment module 82 and route entries 72. As shown in FIG. 8, at Step 240, the reassignment module 82 waits for a user to initiate reassignment, e.g., by activating a link button or by entering a keyboard command. At Step 242, the user selects the bus 24 that is going to be replaced, which might be as a result of the bus being out of service or in use for a special purpose. For this selection, a menu or drop down list may be used listing the buses from the school's bus listings 70. At Step 244, the user selects the bus that is going to take over the replaced bus's route, e.g., a spare bus. Then at Step 246, the replacement module 82 associates in the database 32 the communications identifier of the mobile station 26 in the replacement bus (“Mobile_Replacement”) with the ID 28 of the replaced bus (“ID_Replaced”). Thus, when a parent initiates the notification service using ID_Replaced (the ID of the bus that normally services the house 36), instead of polling the location of the mobile station in the replaced bus, the tracking application system 30 polls the location of the mobile station in the replacement bus. At Step 248, the user is able to designate the status of the replaced bus. If the replaced bus is out of service or on special assignment, the reassignment module 82 terminates, after possibly making a corresponding notation in the database 32, e.g., in the replaced bus's route data entry 72. If the replaced bus is taking over another route, at Step 250 the user selects the bus (“Replaced_Bus_2”) whose route is going to be taken over by the first replaced bus. Then, at Step 252, the reassignment module 82 associates the mobile station identifier of the first replaced bus (“Mobile_Replaced_1”) with the ID 28 of Replaced_Bus_2 (“ID_Replaced_2”). Subsequently, the process is reiterated by returning to Step 248, for designating the status of Replaced_Bus_2.

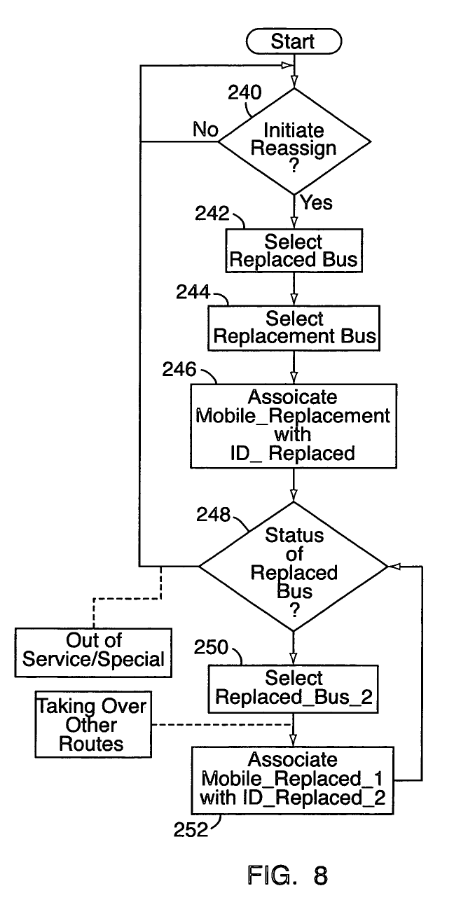

The reassignment module 82 could be implemented in a number of different manners. For example, FIG. 9 shows the reassignment module 82 implemented as a possible graphical user interface. Here, the module 82 would include an initial screen 94 with a list of the bus ID's 28, i.e., a list of all the buses used by a school 62. Each bus ID 28 would be an active link, which could be activated (e.g., “clicked on” using a mouse-driven pointer) for taking the user to the listing 70 associated with the particular bus ID 28. Next to each bus ID 28 would be a means 96 for selecting among the school's different bus routes, e.g., a drop down menu, or, as shown, radial buttons. Clicking on the radial buttons would automatically change the buses' respective routes, with the tracking application 30 re-associating the various bus ID's 28 and mobile station identifiers 34 in a manner akin to the method shown in FIG. 8. The reassignment module 82 could also be provided with a route scheduler 98, accessible from an active link 100, whereby schools could add routes 102, delete routes 104, modify routes 106, or view information 108 relating to the routes, e.g., a schedule 110 and route map 112, by clicking on route links 114.

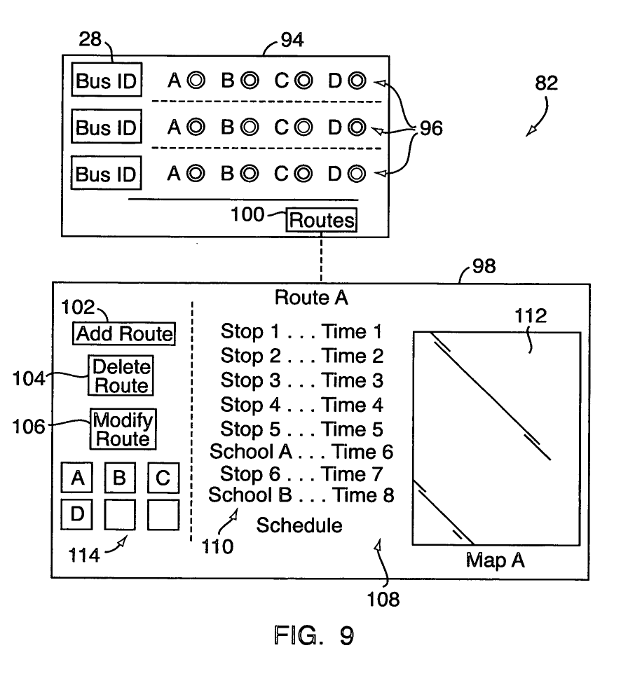

To avoid having to inform parents or students of changes to the bus ID's 28, and/or to simplify the reassignment process, each ID could be associated with a particular bus route instead of with a particular bus, or the parents/students could be provided with a route ID instead of a bus ID, i.e., there could be both route ID's and bus ID's. Thus, for example, with reference to FIG. 10, the database 32 could include a route listing 116 including the various bus routes, each with an optional associated ID, and a bus listing 118 including the ID's of the various buses, an identifier for the mobile station carried by each bus, and the routes serviced by each bus. In initiating a notification from the tracking application 30, the parent or student would provide the route ID, and then the tracking application 30 would look up the mobile station identifier of the bus servicing that route, as provided in the bus listing 118.

Returning to FIG. 7, the tracking application system 30 could be provided with a software module or other functionality 84 (referred to hereinafter as “parent module” 84) for parent or student access. The parent module 84 would allow each parent or student to set up an account 86 on the tracking application 30. Through the account 86, parents or students would schedule notifications on an ongoing basis, without have to phone in the ID 28 and radius 38 every school day. Thus, each account 86 would include the dates 88 for notification, the pre-scheduled times 90 the tracking application system 30 should begin polling, the bus ID 28, the radius 38, the communications identifier 92 of the parent mobile station 40, and/or the location of the house 36. In operation, on the appointed dates and times, the tracking application system 30 would begin polling, as described above, based on the ID 28, radius 38, and parent mobile identifier or location, as stored in the account 86 in the database 32.

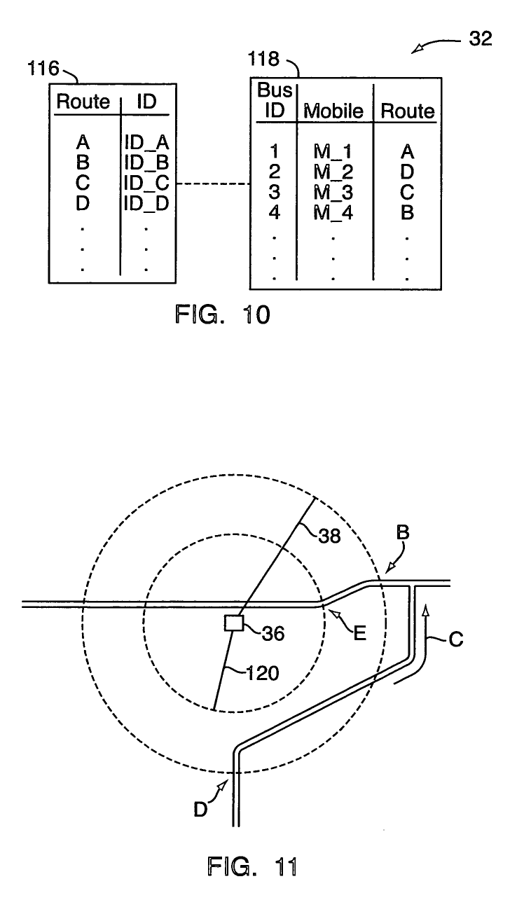

Typically, the radius 38 will be chosen to provide a sufficient notice to the parent or student, based on the schedule of the bus 24 that services the house 36. However, with reference to FIG. 11, there may be situations where a comparison between the location of the parent mobile station 40 and the bus mobile station 26 will provide inaccurate results. This may happen if the bus 24 follows a more complicated route that first takes the bus within the radius 38 and then outside the radius 38 before reaching the home 36. For example, in FIG. 11, if a bus 24 takes a route C, but proper notice (e.g., 5 minutes) is provided at point B, the bus 24 will actually enter within the radius 38 at point D, which may be too far in advance for accurate notification. This eventuality can be compensated for in several manners.

To elaborate, the tracking application system 30 can alert the parent or student the first time the bus enters within the radius 38, e.g., at point D. Knowing the bus's route between point D and the house or bus stop 36, this will provide the student or parent with an estimation of when the bus will arrive at the house 36. However, because the bus may be delayed between point D and the house 36, the estimation may be inaccurate. Additionally, the tracking application system 30 will not know if the bus 24 has entered the radius at point B or point D, and will not be able to convey this information to the parent. For example, if the bus is very early, an alert relating to the bus 24 entering the radius at point B may be sent at the time when the parent expects to receive an alert about the bus entering at point D, possibly causing the student to miss the bus.

As an alternative solution, a more advanced tracking algorithm could be utilized for tracking the bus 24, in a manner that accounts for the bus's particular route. To improve the accuracy of the algorithm, a parent or student would initiate the notification service well in advance of the earliest time the bus 24 would ever reach point D, to ensure that the tracking starts before the bus enters the radius 38 for the first time. As should be appreciated, instead of arriving early, it is more likely that the bus will arrive late because of weather or traffic problems. To ensure that the tracking begins early enough and/or at the proper time each day, ongoing polling times could be scheduled in advanced using the parent module 84, as described above. This is because the tracking application 30 would initiate polling at the same time every school day, according to the pre-set schedule, and not subject to the vagaries of a parent or student calling in at different times.

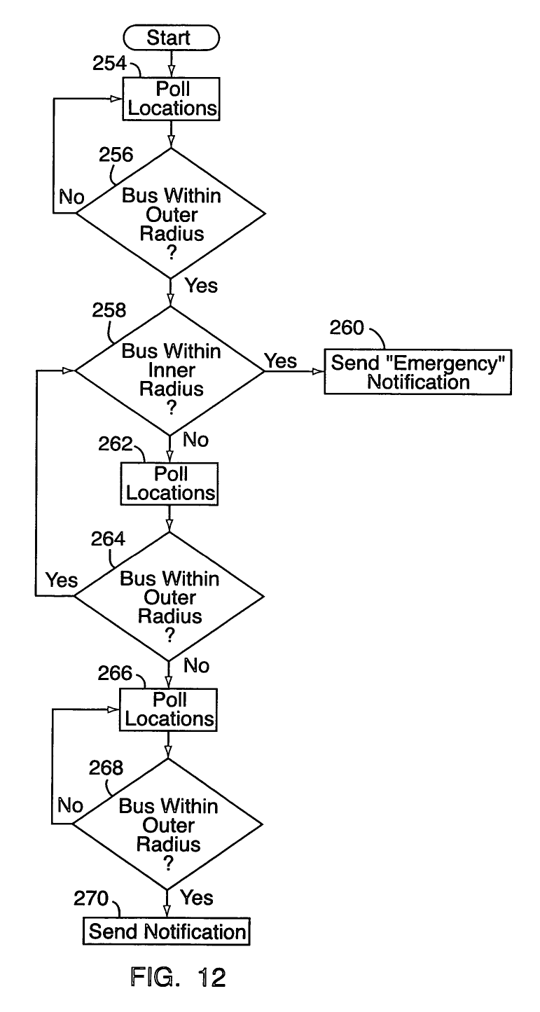

FIG. 12 shows one example of an advanced tracking algorithm that takes into account the route shown in FIG. 11. There, at Step 254, the locations of the bus and parent mobile stations are polled, and the location of the bus with respect to the radius 38 (“outer radius”) is calculated, at Step 256. If outside the outer radius 38, the locations are polled until the bus 24 comes within the outer radius 38. At Step 258, a calculation is made as to whether or not the bus 24 is within an inner radius 120. The inner radius 120 represents the largest distance within the outer radius 38 where the bus 24 only enters the radius at one point, i.e., in the case of the outer radius 38 the bus enters at point D and then at point B, whereas in the case of the inner radius 120 the bus only enters at point E. If the bus 24 comes within the inner radius 120, it is known with certainty that the bus is approaching the house 36, and is not along some other part of its route that happens to come within the outer radius 38. Thus, if the bus is within the inner radius 120, an “emergency” notification is sent out at Step 260 to the parent or student, as an alert that the bus is rapidly approaching. In effect, this acts as a backup notification if the polling is started late for some reason. For example, if the location polling starts before the bus 24 reaches point D, the emergency notification 260 would never be sent. However, if the polling begins late, e.g., just before the bus reaches point B, once the bus crosses point B the tracking application system 30 will not know if the bus is passing point D or point B. A notification could be sent out, but if the bus is actually going past point D, then the notification would be too early. Checking against the inner radius 120 acts as a backup, providing at least some notice, while precluding early notices. At Step 258, if the bus 24 is not within the inner radius 120, the locations are polled at Step 262. Then, at Step 264, a calculation is made as to whether the bus is within the outer radius 38. If so, the algorithm returns to Step 258 for another comparison to the inner radius 120. If not, the locations are against polled at Step 266, and another calculation is made at Step 268 as to whether the bus is within the outer radius 38. If not, the polling/calculation process continues, and if so, a regular notification is sent at Step 270.

The algorithm in FIG. 12 presupposes that the bus enters the outer radius 38 only twice. For different routes, other algorithms could be used, or the algorithm presented could be appropriately modified. Also, the radius 38 could be adjusted, either outwards or inwards, to streamline the tracking process while still providing sufficient notice.

As an alternative to determining the location of the bus mobile station 26 in relation to the house location 36 and a radius 38, a calculation could instead be made with respect to a location along the bus route that would provide sufficient notice to the student or parent of the bus's imminent arrival. For example, with reference to FIG. 11, instead of determining when the bus comes within the radius 38, bus location could be periodically polled for determining when the bus comes within a very short radius of point B. This might enable the use of a simpler tracking algorithm, but would require that the coordinates of point B be determined in advance and stored in the database 32. This could be done by referencing point B on a map in terms of longitude/latitude. It could also be done by a user prompting the tracking application 30 to poll the location of a mobile station temporarily deployed at point B, according to the following. First, the parent would determine a point B along the bus route that provides sufficient notice, and would take his or her mobile station 40 to point B. Next, the parent would send a text message to the tracking application 30 including the parent's account number for the parent module 84 and a special command or instruction. Then, the tracking application 30 would cause the location of the parent mobile station to be polled and, based on the special command, the location would be stored in the parent's account for future use by the system 20. Finally, the tracking application 30 would send a confirmation text message back to the parent mobile station notifying the parent that the procedure has been successfully completed.

There may be situations when it is not possible to determine the location of the bus 24. For example, the bus mobile station may be out of service, or the bus may be in a location where wireless connection to the cellular network is intermittent or non-existent. In such cases, the tracking application system 30 would send a text message or other alert to the parent or student notifying them that “A determination of bus location cannot be made at this time,” or the like.

In a general or overall sense, the tracking application system 30 can be characterized as implementing a method. In a first step, the location of the mobile station 26 carried on the school bus 24 is polled using the cellular network's location polling function 44. (Although the tracking application 30 does not directly determine the location of the mobile stations, the term “poll” is used broadly herein to also include the tracking application's interactions with the location polling function 44.) Typically, this is done after the tracking application system 30 receives some sort of stimulus, e.g., either a call or message from the parent mobile station 40 (containing the bus ID 28 and radius 38), or an alert or other notice from the parent module 84 or other scheduling program/module corresponding to a pre-scheduled time/date for initiating the tracking function. Subsequently, it is determined if the location of the bus mobile station 26 (and hence the bus 24) satisfies one or more criteria in regards to the location of the house 36, e.g., whether the bus 24 is within the radius 38. If so, a notification is sent to the parent mobile station 40 or other device, e.g., a computer, alerting the parent or student that the bus 24 is approaching.

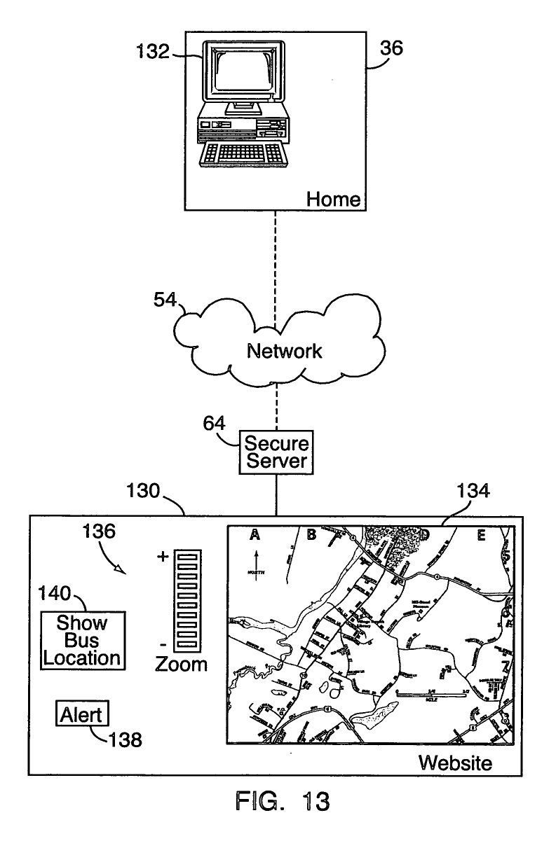

FIG. 13 shows an Internet website 130 that could be optionally implemented as part of, or as a separate embodiment of, the school bus tracking and notification system 20. The website 130 would likely be maintained on the secure server 64 as part of tracking application system 30. The website 130 would be accessible by an Internet-connected computer terminal 132 or the like located at the house or other location 36, in a standard manner as well known by those with skill in the art. The website 130 would include a computer-generated map 134 and standard computer mapping functions such as a “zoom bar” 136.

In operation, the school bus 24 would be tracked in a manner as described above. Additionally, upon a student or parent accessing the website 130, the location of the school bus 24 would be displayed on the map 134. More specifically, the tracking application system 30 would generate information accessible through the website 130 for use in displaying the location of the bus mobile station 26 on the computer-generated map 134 displayed on the computer 132. (In other words, the website 130 merely transmits information to the computer 132, which converts it in a standard manner for graphical display on the computer 132.) The map 134 could either be centered to the location of the house 36, i.e., the student would only be able to see the area in the vicinity of his or her house, or the map 134 could cover an entire region such as a town or city. This would allow the student or parent to follow the bus's progress on the map 134 while working on the computer 132. Also, instead of (or in addition to) the tracking application system 30 sending a message or the like to the mobile station 40 in the house 36 notifying the parent or student that the bus 24 is within the designated radius 38, an alert 138 could be displayed on the computer 132 by way of the website 130.

As should be appreciated, the website 130 would be operably linked to the parent module 84 for allowing a parent or student to enter information relating to the bus 24, e.g., bus ID 28, designated radius 38, and scheduling information 88, 90. For example, upon accessing the parent module 84, the user could be given an option to link to the map 134 for graphically displaying the bus's location. The location of the bus mobile station 26 could be periodically polled on an ongoing basis, with the location information being continuously available on the website 130. However, to conserve location polling resources, location polling could begin upon the receipt of a request from the user or otherwise, e.g., a text message from the mobile station 40, an e-mail message, a daily pre-scheduled notice from the parent module 84, or by activating a request link 140 on the website 130. Polling could continue for a set time period, or it could cease when some criteria is satisfied, e.g., when the website 130 is exited or when the bus comes within the radius 38.

As noted, the present invention is applicable to tracking non-vehicle objects such as packages, cargo, and persons. As an example, an important package could be tracked in the following manner. First, an individual desiring to track the package would insert a mobile station 26 (e.g., cell phone) into the package prior to its being sealed. Then, the package would be posted in a normal manner. For tracking, the user would send a stimulus to the tracking application system 30. The stimulus could be a text message sent from a remote device 40 operated by the user, such as a second mobile station. The stimulus would include the communications identifier of the tracked mobile station 26. (In the present context, although the user owns the tracked mobile station, the user would still be considered a “third party” because the tracked mobile station is not currently under the user's control.) Upon receipt of the stimulus, the tracking application system 30 would poll the location of the mobile station 26 in the package. Then, the tracking application system 30 would send a notification back to the remote device 40. The notification could contain: i) the coordinates of the tracked mobile station 26; and/or ii) the distance between the tracked mobile station 26 and remote device 40; and/or iii) a notification alerting the user that the location of the tracked mobile station 26 satisfies one or more criteria with respect to the location of the remote device 40, or another second location. For the latter two options, the tracking application system 30 would also poll the location of the remote device 40.

Since certain changes may be made in the above-described school bus tracking and notification system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of tracking a first mobile station comprising the steps of:
polling the location of the first mobile station; and
sending a notification regarding the location of the first mobile station to a remote device.

2. The method of claim 1 further comprising the step of:
receiving from the remote device a stimulus to commence the step of polling the location of the first mobile station.

3. The method of claim 2 wherein:
the remote device is a second mobile station;
the first and second mobile stations are operably connected to at least one cellular communications network having short messaging service (SMS); and
the notification and stimulus are sent and received, respectively, through the SMS.

4. The method of claim 2 wherein the stimulus comprises an identifier associated with the first mobile station.

5. The method of claim 4 wherein:
the identifier is an object identifier of an object associated with the first mobile station; and
the method further comprises the steps of:
storing the object identifier and a communications identifier of the first mobile station; and
determining the communications identifier based on the object identifier for use of the communications identifier in polling the location of the first mobile station.

6. The method of claim 1 wherein:
the method further comprises the step of determining if the location of the first mobile station satisfies one or more criteria in regards to a second location; and
the step of sending the notification is only carried out upon determining that the one or more criteria are satisfied.

7. The method of claim 6 further comprising the step of:
receiving from the remote device a stimulus to commence the step of polling the location of the first mobile station, wherein the remote device is positioned at the second location.

8. The method of claim 6 wherein:
the remote device is positioned at the second location; and
the method further comprises the step of polling the location of the remote device for obtaining information relating to the second location.

9. The method of claim 6 wherein the location of the first mobile station is polled periodically until a determination is made that the location of the first mobile station satisfies the one or more criteria.

10. The method of claim 6 wherein the one or more criteria comprises the location of the first mobile station being within a designated radius of the second location.

11. The method of claim 10 wherein the location of the first mobile station is polled periodically until a determination is made that the location of the first mobile station satisfies the one or more criteria.

12. The method of claim 11 wherein a rate of periodically polling the location of the first mobile station is based on the distance between the location of the first mobile station and the designated radius.

13. The method of claim 1 further comprising the step of:
receiving a stimulus to commence the step of polling the location of the first mobile station, wherein the stimulus comprises a pre-scheduled notice received from a scheduling program.

14. The method of claim 1 further comprising the step of:
generating information accessible through an Internet website for use in displaying the location of the first mobile station on a computer-generated map.

15. A method of tracking a first mobile station comprising the steps of:
receiving a stimulus to poll the location of the first mobile station from a remote device; and
polling the location of the first mobile station based on the stimulus.

16. The method of claim 15 wherein:
the remote device comprises a second mobile station; and
the method further comprises the step of sending a notification regarding the location of the first mobile station to the second mobile station.

17. The method of claim 15 wherein the stimulus comprises a communication to a scheduling program for later initiation of the step of polling the location of the first mobile station.

18. A method of tracking a first mobile station comprising the steps of:
determining if a location of the first mobile station satisfies one or more criteria in regards to a second location; and, if so:
sending a notification to a remote device.

19. The method of claim 18 wherein:
the remote device is a second mobile station at the second location; and
the method further comprising the step of polling the respective locations of the first and second mobile stations for use in determining if the location of the first mobile station satisfies the one or more criteria in regards to the second location.

20. The method of claim 19 wherein the one or more criteria comprises the location of the first mobile station being within a designated radius of the second location.
